(19) United States
(12) Patent Application Publication
(10) Pub. No.: US 2009/0283034 A1
(43) Pub. Date: Nov. 19, 2009

(54) WAFER HOLDER, MANUFACTURING METHOD THEREOF AND SEMICONDUCTOR MANUFACTURING APPARATUS

(75) Inventors: Masuhiro Natsuhara, Hyogo (JP); Tomoyuki Awazu, Hyogo (JP); Kenji Shinma, Hyogo (JP); Hirohiko Nakata, Hyogo (JP)

Correspondence Address: GLOBAL IP COUNSELORS, LLP, 1233 20TH STREET, NW, SUITE 700, WASHINGTON, DC, 20036-2680, US

(73) Assignee: Sumitomo Electric Industries, LTD., Osaka-shi Osaka (JP)

(21) Appl. No.: 11/996,728

(22) PCT Filed: May 21, 2007
(86) PCT No.: PCT/JP2007/060327

§ 371 Date: Jan. 24, 2008

(30) Foreign Application Priority Data
May 24, 2006 (JP) 2006-143506

(51) Int. Cl. B05C 13/02; B32B 38/14

(52) U.S. Cl. 118/500; 156/277

(57) ABSTRACT

A wafer holder is provided that can be used in wafer processes at room temperature or lower and that is particularly suited for use in a CVD apparatus.

The wafer holder 1 has a wafer-mounting surface. The wafer holder 1 is made of ceramic and has a flow channel 3 that allows coolant to flow to the interior of the wafer holder in order to cool the wafer holder 1, and is furthermore preferably provided with a high-frequency generating electrode 2. The wafer holder 1 can be manufactured having a flow channel 3 formed in one of the ceramic substrates, at least another ceramic substrate is joined to the ceramic substrate so as to cover the flow channel 3, and a ceramic plate in which a high-frequency generating electrode 2 is formed is preferably additionally joined to the other substrates.

### FIELD OF THE INVENTION

The present invention relates to a wafer holder used in a semiconductor manufacturing apparatus, and more specifically relates to a wafer holder for treating a wafer at a lower temperature than normal temperature, and to a semiconductor manufacturing apparatus on which the wafer holder is mounted.

### BACKGROUND ART

In conventional semiconductor manufacturing processes, the wafer is heated in a CVD apparatus or the like, or plasma is generated to form an insulation film, electroconductive film, or another film on the wafer surface. Ceramic wafer holders are known as so-called susceptors used as the wafer holders for performing these processes.

In Japanese Published Examined Application No. 06-028258, for example, a configuration is described in which a heat source is embedded in the ceramic wafer holder and a convex support part is furthermore mounted on the holder to obtain a highly reliable wafer holder. In Japanese Laid-Open Patent Application Publication No. 2002-025913, a susceptor in which a metal heat sink is mounted on a ceramic heater is disclosed, and the ceramic heater and metal heat sink can be mounted using a simple method.

Another susceptor is disclosed in Patent Document: Japanese Laid-Open Patent Application Publication No. 2002-025913.

### SUMMARY OF THE INVENTION

In recent years, the ability to form a film at lower temperatures in such CVD apparatuses has advanced, and in some cases there is a need to form a film at a temperature that is less than room temperature. Since the metal components in the chamber become contaminants and contaminate the wafer, there is a need to reduce such contamination.

However, the above-mentioned conventional wafer holders are designed under the assumption that the wafer will be processed at temperatures that are higher than room temperature, e.g., 400° C. or higher. Therefore, it has been difficult in recent years to use such wafer holders in processes that are carried out at room temperature or lower.

The present invention was contrived in view of the foregoing, and an object thereof is to provide a wafer holder that can be used in wafer processes that are carried out at room temperature or lower and that are used in CVD apparatuses in particular.

### Means for Resolving the Problems

The present invention, in order to achieve the above-described objects, provides a wafer holder for a semiconductor manufacturing apparatus that has a wafer mounting surface for mounting a wafer, wherein the wafer holder is made of ceramic and having a flow channel that allows coolant to flow to the interior of the wafer holder.

The present invention provides a method for manufacturing a wafer holder for a semiconductor manufacturing apparatus that is made of ceramic and that has a flow channel for allowing coolant to flow to the interior of the wafer holder, wherein a flow channel is formed on a single ceramic substrate, and at least one ceramic substrate is joined above and/or below the ceramic substrate so as to cover at least the flow channel.

Furthermore, the present invention provides a semiconductor manufacturing apparatus wherein the above-described wafer holder for a semiconductor manufacturing apparatus is mounted in the semiconductor manufacturing apparatus, and provides a CVD apparatus in particular.

### Effects of The Invention

In accordance with the present invention, a flow channel that allows coolant to flow directly to the interior of a ceramic wafer holder is provided, and the wafer holder can be used to form a film or carrying out other processes at room temperature or lower. However, since the wafer holder is made of ceramic, there is no contamination produced by metal components, and since the wafer holder has high corrosion resistance to corrosive gases used during film formation and cleaning, a highly reliable wafer holder and semiconductor manufacturing apparatus can be provided.

### BRIEF DESCRIPTION OF DRAWINGS

FIG. 1 is a schematic cross-sectional view showing a specific example of the wafer holder of the present invention.

### EXPLANATION OF REFERENCE NUMERALS

1: Wafer holder
1a: Wafer Mounting Body
A: Substrate
B: Substrate
C: Substrate
S: Wafer Mounting Surface
T: Tungsten electrode
E₁: Entrance
E₂: Exit
2: High-frequency generating electrode
3: Flow channel
4: Cooling tube
5: Thermocouple
6: Electrode pipe
7: Cylindrical support element
8: Concavity
9: Aperture

### BEST MODE FOR CARRYING OUT THE INVENTION

In the present invention, a wafer holder 1 includes a wafer mounting body 1a that includes three substrates A, B and C and a support element 7, that are described below. The mounting body 1a includes a wafer mounting surface S. The mounting body 1a also includes a flow channel 3 that allows coolant for cooling the wafer holder 1 to flow. The flow channel 3 is formed inside the ceramic wafer mounting body 1a. For this reason, coolant that flows through the flow channel 3 takes heat away from the wafer holder 1, and efficiently allows the wafer holder 1 to be constantly kept at a low temperature. Therefore, the wafer holder 1 can be advantageously used in film formation and other currently required processes that are carried out a room temperature or lower, and a uniform film thickness can be obtained because the temperature can be reduced to room temperature or lower even if the temperature of the wafer (not shown) increases during film formation.

The coolant that is allowed to flow into the wafer holder 1 is not particularly limited, and examples include water and organic solvent. However, water cannot be used at 0° C. or lower due to the recent trend of using lower film formation temperatures. Therefore, Galden, alcohol, or another organic solvent is preferably used. These solvents allow the temperature to be reduced to the freezing point or lower. For example, water can be used by mixing the water with alcohol to bring the temperature to 0° or lower. Water in particular has a relatively large specific heat in comparison with other coolants, and efficient cooling can be expected. Although the cooling efficiency is inferior to these coolants, it is also possible to use, e.g., nitrogen, helium, air, and other low temperature gases.

The flow channel 3 formed inside the wafer holder 1 is preferably formed in 80% or more of the area with respect to the diameter of the wafer to be mounted. If, for example, the diameter of the wafer is 200 mm, the flow channel is preferably present in an area having a diameter of at least 160 mm from the center of the wafer holder 1. When the flow channel 3 is not present in such an area, the external peripheral portion of the wafer holder 1 will absorb heat from the surrounding environment, the temperature of the vicinity about the external peripheral portion of the wafer will increase, and the formation of a uniform film therefore becomes difficult. The flow channel 3 is furthermore preferably formed in an area that is at least the same as the diameter of the wafer from the center of the wafer mounting body 1a. When the coolant flow channel 3 is formed in such an area, the temperature of the edge portion of the wafer will not increase and uniform film formation is made possible.

The surface roughness of the inner wall of the flow channel is preferably 5 μm or less in terms of Ra. When the surface roughness of the inner wall of the flow channel 3 is greater than 5 μm, an unfavorable situation occurs in which the surface of the inner wall of the flow channel 3 tends to be corroded by the coolant, particularly when a liquid coolant is used, and the surface of the wall tends to degrade. The cross-sectional shape of the flow channel 3 is not particularly limited, but a circle, square, oval, semicircle, triangle, and various other shapes may be used.

The material used in the wafer mounting body 1a is not particularly limited as long as the material is a ceramic. Aluminum nitride, silicon carbide silicon nitride, alumina, mullite, cordierite, and the like may be used. Among these, however, aluminum nitride is advantageous. Aluminum nitride is very resistant to corrosion by the corrosive gases used in a conventional semiconductor manufacturing apparatus (not shown), and the generation of particles in the chamber can be considerably reduced. Since aluminum nitride has relatively high thermal conductivity and a low specific heat, the wafer holder 1 can be uniformly and efficiently cooled.

The surface roughness of the wafer holder 1 itself is preferably 0.01 μm in terms of Ra. If the surface roughness is 0.01 μm or higher, heat can be exchanged from small projections in the surface, heat exchange over a wide surface area is made possible, and the wafer holder 1 can be efficiently cooled. The temperature in the wafer holder 1 can be controlled by disposing, e.g., a thermocouple 5 or another temperature-sensing element in an aperture 9 in the wafer mounting body 1a and extending through a concavity 8 formed in the cylindrical support element 7 of the wafer holder 1 and controlling the temperature of a chiller or other component that cools the coolant on the basis of the temperature measured by the temperature-sensing element (i.e., the thermocouple 5).

A high-frequency generating electrode 2 may be disposed inside the wafer mounting body 1a of the wafer holder 1 of the present invention, as described below. Plasma can be generated in the vicinity of the wafer mounting surface S by providing a high-frequency generating electrode, and a film can be formed on the wafer. The high-frequency generating electrode 2 is preferably embedded in the wafer mounting body 1a of the wafer holder 1.

Examples of such a high-frequency generating electrode 2 include a metal mesh, metal foil, or metal film, but preferred among these is a metal film. When the high-frequency generating electrode 2 is made of a metal film, stable plasma generation can be relatively easily achieved because the high frequency that is used does not easily leak into the lower portions of the film. The material of the high-frequency generating electrode 2 that can be embedded in a ceramic wafer holder is preferably a metal that has a relatively low coefficient of thermal expansion inside the metal because the coefficient of thermal expansion must be matched with the ceramic, and preferred examples include tungsten, molybdenum, tantalum, other metals, and alloys.

The wafer holder 1 of the present invention is disposed inside a conventional chamber (not shown) of the semiconductor manufacturing apparatus, and the cylindrical support element 7 is therefore preferably disposed on a surface of the wafer mounting body 1a opposite from the wafer mounting surface S. For example, if the support element 7 is a cylinder having a cylindrical shape or the like, cooling tubes for supplying coolant, electrode components connected to the high-frequency generating electrode, temperature-sensing elements for measuring the temperature of the wafer holder, and other components can be accommodated inside the cylindrical support element 7.

The cylindrical support element 7 can be airtightly sealed against the wafer mounting body 1a of the wafer holder 1, and can be furthermore airtightly sealed against the chamber of the semiconductor manufacturing apparatus. In the case of such an airtight sealed structure, the material of the cylindrical support element 7 can reduce the generation of stress caused by a difference in the coefficient of thermal expansion by making the material of the cylindrical support element 7 and the material of the wafer mounting body 1a of the wafer holder 1 to be the same, and a highly reliable joined structure can be obtained. Such a situation is preferred in that the metal components accommodated inside the cylindrical support element 7 are not exposed within the chamber, and the generation of metal contaminants can be reduced.

However, in the airtight sealed structure, when the interior of the cylindrical support element is open to atmosphere, condensation tends to occur around the coolant-supplying cooling tubes when the wafer holder is cooled, and the corrosion of the metal components and ceramic increases. Condensation can be prevented in such a case by feeding dry gas into the cylindrical support element 7. Condensation can also be prevented by sealing the interior of the cylindrical support element 7 from outside air and feeding dry gas into its interior. In either case, the dew point of the atmosphere in the cylindrical support element must be made to be at least 0° C. or higher.

Another mode of the airtight seal is one in which the atmosphere inside the cylindrical support element 7 is kept essentially the same as the atmosphere inside the chamber of the semiconductor manufacturing apparatus. The cylindrical support element 7 in this case can be fixed using a plurality of screws (not shown) in the wafer holder 1, for example. The merits of this method are that the components inside the cylindrical support element 7 do not undergo condensation and the structure is relatively simple. Naturally, in the case of such a structure, corrosion of the metal components can be reduced by sending inert gas into the cylindrical support element 7 and making the pressure of the atmosphere inside the cylindrical support element 7 to be relatively higher than that of the chamber of the semiconductor manufacturing apparatus. In this case, the atmosphere inside the cylindrical support element 7 must be such that the dew point is 0° C. or lower.

Next, the method for manufacturing a wafer holder such as the wafer holder 1 according to the present invention is described. The wafer mounting body 1a of the wafer holder 1 internally provided with a coolant flow channel 3 is manufactured by joining a plurality of ceramic substrates A, B and C, but the wafer holder 1 may be manufactured in such a case by forming the flow channel 3 on the ceramic substrate A and mounting and joining another ceramic substrate B so as to cover the flow channel on at least the surface on which the flow channel 3 is formed.

This method is preferred due to the fact that the flow channel 3 can be formed with relatively good precision and the flow channel 3 is not likely to deform because the flow channel 3 is formed on a sintered ceramic substrate A. For example, in a method in which the flow channel is formed on an unsintered ceramic molded article and the article is then sintered, the flow channel locally narrows or widens. In the case of such a flow channel, the side surfaces of the flow channel are more easily corroded by coolant because the flow rate locally increases or decreases, particularly when the coolant is a liquid.

A known joining paste may be used to join the ceramic substrates A, B and C. In the particular case that the wafer mounting body 1a of the wafer holder 1 is made from aluminum nitride, a paste composed of a mixture of aluminum nitride, aluminum oxide, and rare earth oxides is preferably used. This paste is particularly preferred for its excellent corrosion resistance when the joining is carried out by a heat treatment because the primary component of the ultimately formed joining layer is aluminum nitride and the wettability in relation to aluminum nitride is excellent.

The aluminum nitride content of the joining paste for the aluminum nitride substrate is preferably 1 wt % or higher. When the aluminum nitride content is less than 1 wt %, the corrosion resistance is inferior because the amount of aluminum nitride in the joining layer component is low. When the aluminum nitride content exceeds 40 wt %, the adhesive strength is reduced. The aluminum nitride content is therefore preferably 40 wt % or less. An aluminum nitride content of 5 to 30 wt % is particularly preferred, and an aluminum nitride content that is in a range of 15 to 25 wt % is even more preferred because a particularly stable joining layer can be obtained.

The content of the aluminum oxide in the joining paste is preferably 20 to 80 wt %. When the aluminum oxide content in the joining paste is less than 20 wt % or is greater than 80 wt %, an undesirable situation occurs in which the temperature of forming the liquid phase for joining is increased and the aluminum nitride substrate is more easily deformed. A content of 40 to 60 wt % is particularly preferred, and as long as the content is in this range, the aluminum nitride substrate can be prevented from deforming because joining can take place at a temperature that is lower than the sintering temperature of the aluminum nitride.

The content of the rare earth oxides in the joining paste is preferably 10 to 50 wt %. A preferable situation is obtained if the content is in this range because a reaction with the aluminum oxide occurs and a liquid phase can be more easily generated. Since the rare earth oxides have excellent wettability with aluminum nitride, a favorable situation can be achieved in that stable joining can be performed as long as the content of the rare earth oxides is 20 to 40 wt %, and the joining boundary between the joining layer and the aluminum nitride substrate can be made airtight.

The rare earth oxides used in the paste are not particularly limited, but are preferably the same type of rare earth oxide as that of the sintering aid used in the aluminum nitride substrate to be joined. When a sintering aid is not included in the aluminum nitride substrate, any rare earth oxide may be used. Particularly preferred among rare earth oxides are oxides of yttrium for their corrosion resistance and excellent wettability with aluminum nitride.

A specific method for joining aluminum nitride substrates involves mixing prescribed amounts of aluminum nitride powder, aluminum oxide powder, and rare earth powder; adding organic solvents, binders, plasticizers as required, and other additives to the mixture; and kneading the mixture to produce a paste. The paste is coated onto the surface of the aluminum nitride substrate that is to be joined, the surface is degreased as required, another aluminum nitride substrate is mounted on the coated surface, and a strong joining surface can be formed by heat treatment.

The temperature and pressure during joining are not particularly limited, but a temperature and pressure are preferably in a range that does not cause the aluminum nitride substrate to deform. Specifically, the heat treatment temperature depends on the composition of the paste, and about 1,600 to 2,000° C. is advantageous. During the heat treatment, pressure is preferably applied from a vertical direction with respect to the joining surface so that a joining layer having few defects can be formed. The pressure to be applied is preferably 1 kg/cm² or more, and even more preferably 10 kg/cm² or more.

When a high-frequency generating electrode 2 is to be formed inside the wafer mounting body 1a of the wafer holder 1, an electrode made of a metal film that is formed using screen printing is particularly preferred. In accordance with screen printing, the resulting film thickness is relatively uniform, costs are low, and productivity is high. The electrode-forming paste used in screen printing may be one in which a binder and an optional plasticizer are added to tungsten, molybdenum, tantalum, or another high-melting point metal powder to form a paste.

Specifically, a high-frequency generating electrode 2 made of a metal film can be obtained by coating the electrode-forming paste onto a ceramic substrate by using screen printing, drying the paste, and then baking the dried paste at a temperature of 1,600 to 2,000° C. in a nonoxidizing atmosphere. A ceramic substrate is then joined using the above-described joining method, whereby a wafer holder having a high-frequency generating electrode 2 in the interior of the wafer holder 1 can be relatively easily manufactured. It is apparent that a joining process that forms the flow channel 3 through which coolant flows and a joining process that embeds the high-frequency generating electrode 2 can be carried out at the same time. A wafer holder 1 can be manufactured at relatively low cost by using this simultaneous joining.

The wafer holder 1 according to the present invention can be advantageously used in semiconductor manufacturing processes that require the wafer to be cooled. For example, the wafer holder can be mounted in a semiconductor manufacturing apparatus, and etching, ashing, CVD and other processes can be carried out. In a CVD apparatus in particular, efficient film formation can be achieved by mounting a wafer holder in which a high-frequency generating electrode is embedded.

### WORKING EXAMPLES

### Working Example 1

Yttrium oxide powder (0.5 wt %) was added as a sintering aid to aluminum nitride powder (99.5 wt %), an organic solvent and a binder were furthermore added, and the system was mixed using a ball mill to form a slurry. The resulting slurry was spray-dried to form granules, and a molded article was formed by press molding. The molded article was degreased at 800° C. in a nitrogen atmosphere and then sintered at 1,900° C. in a nitrogen atmosphere to obtain a sintered body made from aluminum nitride.

Three sintered bodies made from aluminum nitride were formed using the above method, and these sintered bodies were used as aluminum nitride substrates. Specifically, one of the sintered bodies was formed to a diameter of 330 mm and a thickness of 10 mm to form the substrate A, and thereafter machined to form a coolant flow channel 3 having a depth of 3 mm and a width of 6 mm. Since the diameter of the wafer to be mounted on the wafer holder 1 was 300 mm, the area for forming the flow channel 3 had a diameter of 310 mm from the center of the wafer holder 1. The surface roughness of the inner wall of the flow channel was 1.0 μm in terms of Ra. The entrance E₁ and exit E₂ of the flow channel 3 were formed so as to be in the vicinity of the center portion of the substrate A.

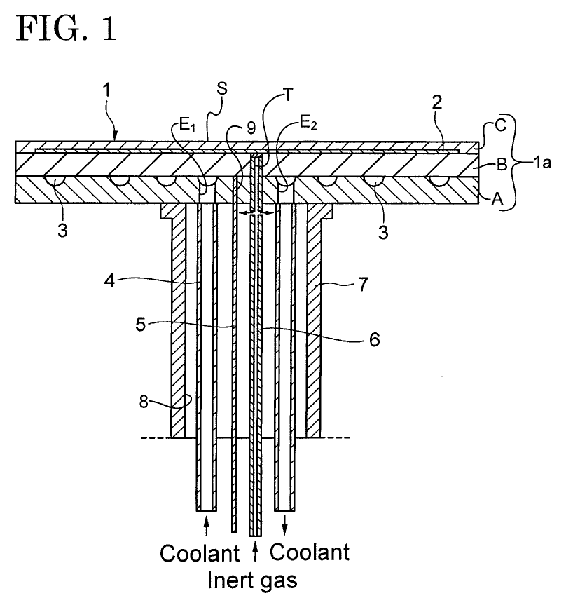

Next, another substrate B was formed to a diameter of 330 mm and a thickness of 5 mm. A tungsten paste composed of tungsten powder, a binder, an organic solvent, and other components was coated using screen printing in an area formed by a diameter of 320 mm from the center of the surface on one side of the substrate B. The substrate B was then degreased at 800° C. and baked at 1,850° C. to form a high-frequency generating electrode 2. The remaining substrate C was formed to a diameter of 330 mm and a thickness of 3 mm. It should be understood from the drawing and the description herein that the relative thicknesses of the substrates A, B and C can vary, depending upon a variety of design considerations. Further, the relative thickness of the substrates A, B and C shown in FIG. 1 is schematic and is not a limiting in any way with respect to the overall dimensions (such as thickness) of the substrates A, B and C.

Among these three aluminum nitride substrates, the substrate B in which a high-frequency generating electrode was formed was coated using a joining paste composed of 20-wt % aluminum nitride, 30-wt % yttrium oxide, and 50-wt % aluminum oxide on the two surfaces of the substrate B by using screen printing, and was degreased at 800° C. in a nitrogen atmosphere. The substrate C having a thickness of 3 mm was mounted on the surface of the substrate B on which the high-frequency generating electrode 2 was formed, the substrate A on which the flow channel was formed on the opposite surface was superimposed so that the flow channel 3 was on the inner side, and the assembly was heated and joined at 1,800° C. in a nitrogen atmosphere while a pressure of 20 kg/cm² was applied in the vertical direction with respect to the joining surface. The substrates A, B and C once joined together, form the wafer mounting body 1a. Lastly, the upper and lower surfaces of the wafer mounting body 1a were polished to obtain an aluminum nitride wafer holder.

The resulting wafer mounting body 1 of the wafer holder 1 was counter-sunk from the opposite side of the wafer-mounting surface S of the wafer mounting body 1a, extending to the high-frequency generating electrode 2, and a tungsten electrode T was mounted on the wafer mounting body 1 of the wafer holder 1, as shown in FIG. 1. Two stainless steel cooling tubes 4 were mounted to the entrance E₁ and exit E₂ in the flow channel 3 of the wafer holder 1. A concavity 9 was formed in the surface of the side opposite from the wafer-mounting surface of the wafer holder 1, and a sheathed thermocouple 5 was mounted. A nickel electrode pipe 6 provided with through-holes in the peripheral wall on the upper side was joined to the tungsten electrode T of the high-frequency generating electrode 2, and inert gas was supplied to the interior of the pipe 6.

The flange portion of the cylindrical support element 7 was joined using screws to the under surface of the wafer mounting body 1a opposite from the wafer-mounting surface S of the wafer holder 1. The cylindrical support element 7 was made from aluminum nitride, and the flange portion had a diameter of 80 mm, an outside diameter of 60 mm, an inside diameter of 50 mm, and a height of 200 mm. The cooling tube 4, thermocouple 5, and electrode pipe 6 were housed inside the cylindrical support element 7.

The wafer holder 1 was disposed inside the chamber of the CVD apparatus. Galden as the coolant was fed through the cooling tube 4 accommodated in the cylindrical support element 7, and allowed to flow to the flow channel 3 of the wafer holder 1. Helium gas having a dew point of −70° C. as the inert gas was fed to the electrode pipe 6 in a ratio of 2 L per minute. The coolant was circulated from the through-holes of the upper side through the cylindrical support element 7, whereby condensation inside the cylindrical support element 7 was prevented and inert gas was prevented from entering the cylindrical support element 7.

The temperature of the wafer holder 1 was kept at −20° C. A wafer having diameter of 300 mm was mounted on the wafer-holding surface S, and a film-forming gas was introduced to the chamber. A high frequency of 3.56 MHz was applied to the high-frequency generating electrode 2 to generate a plasma, whereby a film was formed on the wafer, and the film on the wafer was uniform. The temperature distribution of the wafer in this case was measured using a temperature gauge, and the temperature distribution was kept to −20° C.±1° C.

### Working Example 2

A flow channel 3 was formed in the aluminum nitride substrate A in the same manner as example 1 described above. In this case, the area for forming a flow channel 3 was varied for each example in the manner shown in TABLE 1 below, and the temperature distribution was measured for the case in which the temperature of the wafer holders was kept at 20° C. The results are shown in TABLE 1 below. The results of example 1 are also included in the table for reference. A wafer temperature gauge having a diameter of 300 mm and 29 measurement points was used to measure the temperature of the wafer.

TABLE 1

| | Flow channel formation area | | Wafer temperature |
|---|---|---|---|
| | Outermost | Ratio to | distribution |
| Sample | diameter (mm) | wafer (%) | (−20° C. ± ° C.) |
| 1 (Example 1) | 310 | 103 | 1.00 |
| 2 | 300 | 100 | 1.05 |
| 3 | 280 | 93 | 1.15 |
| 4 | 260 | 87 | 1.20 |
| 5 | 240 | 80 | 1.25 |
| 6 | 220 | 73 | 1.55 |
| 7 | 200 | 67 | 1.95 |

### Working Example 3

An aluminum nitride wafer holder 1 was fabricated in the same manner as example 1 described above. However, the surface roughness of the flow channel 3 was varied, a water-alcohol mixed solvent adjusted to a temperature of −10° C. was washed over the surface for 1,000 hours, and the corrosiveness of the aluminum nitride was confirmed by measuring the pH of the refrigerant after the test. Aluminum nitride is ordinarily relatively stable in atmosphere because an oxide-based film is formed on the surface, but ammonia is generated when moisture makes contact with broken surfaces, polished surfaces, and other portions on which a film is not formed. It was therefore determined that corrosion of the flow channel 3 progresses when the pH is an alkaline pH. The results are shown in TABLE 2 below. The pH prior to testing was 7 in all cases.

TABLE 2

| Surface roughness of | Refrigerant pH |
|---|---|
| the flow channel (Ra: μm) | after testing |
| 0.5 | 7.5 |
| 1.0 | 7.6 |
| 1.5 | 7.8 |
| 2.1 | 7.9 |
| 2.6 | 8.0 |
| 3.2 | 8.1 |
| 3.8 | 8.1 |
| 4.3 | 8.2 |
| 5.0 | 8.3 |
| 5.8 | 9.5 |
| 6.5 | 11.2 |

### Working Example 4

A wafer holder 1 was fabricated in the same manner as example 1 described above, and helium gas was fed into an electrode pipe. In this case, the dew point of the helium gas was varied, the temperature of the wafer holder was kept at −10° C., and a durability test was conducted for 1,000 hours. After the durability test, the state of corrosion of a stainless steel cooling tube and a nickel electrode pipe was visually observed, and the results are shown in TABLE 3 below.

TABLE 3

| Dew point of | | |
|---|---|---|
| He gas (° C.) | Cooling tube (SUS) | Electrode pipe (Ni) |
| −70 | No change | No change |
| −50 | No change | No change |
| −30 | No change | No change |
| −15 | Slight brown | Slight brown |
| | discoloration | discoloration |
| ±0 | Slight brown | Slight brown |
| | discoloration | discoloration |
| +15 | Brown discoloration, | Brown discoloration, |
| | powdering, flying dust | powdering, flying dust |

Upon completion of the 1,000-hour durability test, a film formation test was performed using the wafer holders, and the effects were observed. As a result, a film was formed without problems even after the durability test for samples in which helium gas having a dew point of 0° or less was used, but when the dew point was 15° C., stainless steel and nickel particles were left on the wafer.

### Working Example 5

A wafer holder 1 was fabricated in the same manner as example 1 described above, but the material was changed to silicon nitride, alumina, mullite, cordierite, and silicon carbide. The temperature of the wafer holders was controlled in the same manner as example 1, and the temperature distribution was measured. The results are shown in TABLE 4 below together with the results of example 1. It is apparent from the results that aluminum nitride was most advantageous in terms of thermal uniformity of the wafer.

TABLE 4

| | Temperature distribution of the |
|---|---|
| Material of the wafer holder | wafer (−20° C. ± ° C.) |
| Aluminum nitride (Example 1) | 1.0 |
| Silicon nitride | 2.1 |
| Silicon carbide | 1.5 |
| Alumina | 2.6 |
| Mullite | 3.4 |
| Cordierite | 3.5 |

1. A wafer holder for a semiconductor manufacturing apparatus comprising:
a wafer mounting body having a wafer mounting surface for mounting a wafer, the wafer holder being made of ceramic and having a flow channel that allows coolant to flow inside of the wafer holder body.

2. The wafer holder for a semiconductor manufacturing apparatus according to claim 1, wherein the ceramic of the wafer holder body is aluminum nitride.

3. The wafer holder for a semiconductor manufacturing apparatus according to claim 1, wherein a high-frequency generating electrode is formed inside the wafer holder body.

4. The wafer holder for a semiconductor manufacturing apparatus according to claim 3, wherein the high-frequency generating electrode is a metal film.

5. The wafer holder for a semiconductor manufacturing apparatus according to claim 1, further comprising a cylindrical support element for supporting the wafer holder body, wherein at least one of a cooling tube for supplying coolant, an electrode component connected to the high-frequency generating electrode, and a temperature sensing element for measuring the temperature of the wafer holder body is accommodated inside the cylindrical support element.

6. The wafer holder for a semiconductor manufacturing apparatus according to claim 5, wherein the dew point of the atmosphere in the cylindrical support element is 0° C. or less.

7. A method for manufacturing a wafer holder for a semiconductor manufacturing apparatus that is made of ceramic and that has a flow channel for allowing coolant to flow to the interior of the wafer holder, the method comprising:
forming a flow channel on a first ceramic substrate, and
joining at least one second ceramic substrate to at least one of above and below the first ceramic substrate so as to cover at least the flow channel.

8. The method for manufacturing a wafer holder for a semiconductor manufacturing apparatus according to claim 7, further comprising
forming a high-frequency generating electrode on a third ceramic substrate, and
further joining the third ceramic substrate to one of the first and second ceramic substrate so as to cover at least the high-frequency generating electrode.

9. The method for manufacturing a wafer holder for a semiconductor manufacturing apparatus according to claim 8, wherein
the high-frequency generating electrode forming step includes screen printing the high-frequency generating electrode.

10. The method for manufacturing a wafer holder for a semiconductor manufacturing apparatus according to claim 7, further comprising
forming the first and second ceramic substrates of aluminum nitride;
coating a paste containing aluminum nitride, aluminum oxide, and rare earth oxides onto at least one of the first and second ceramic substrates when first and second ceramic substrates are joined; and
superimposing and heat treating the first and second ceramic substrates.

11. A semiconductor manufacturing apparatus having the wafer holder for a semiconductor manufacturing apparatus according to claim 1.

12. The semiconductor manufacturing apparatus according to claim 11, wherein the semiconductor manufacturing apparatus is a CVD apparatus.

13. The method for manufacturing a wafer holder for a semiconductor manufacturing apparatus according to claim 8, further comprising
forming the first, second and third ceramic substrates of aluminum nitride; and
wherein
the joining step further comprises coating a paste containing aluminum nitride, aluminum oxide, and rare earth oxides onto at least two of the first, second and third ceramic substrates for joining the first, second and third ceramic substrates together; and
superimposing and heating treating the first, second and third ceramic substrates.
